(19) United States
(12) Patent Application Publication
(10) Pub. No.: US 2005/0223756 A1
(43) Pub. Date: Oct. 13, 2005

(54) Retractable wire lock

(75) Inventors: Renny Tse-Haw Ling, Chung-Ho City (TW); Chun-Sheng Wu, Chung-Ho City (TW)

Correspondence Address: APEX JURIS, PLLC, 13194 EDGEWATER LANE NORTHEAST, SEATTLE, WA, 98125, US

(73) Assignee: Sinox Co., Ltd., Chung-Ho City (TW)

(21) Appl. No.: 11/035,633

(22) Filed: Jan. 13, 2005

(30) Foreign Application Priority Data
Apr. 9, 2004 (TW) 93205449

(51) Int. Cl. E05B 73/00

(52) U.S. Cl. 70/30; 70/58

(57) ABSTRACT

A retractable wire lock includes cables or steel wires of different lengths to serve as connection members to couple with a first guarding member and a second guarding member, and a winding reel pivotally located in a casing to couple with and wind the connection members. The winding reel can adjust the length of the connection members according to actual requirements or fully wind the connection members for storing.

### FIELD OF THE INVENTION

The present invention relates to a retractable wire lock that uses a wire or cable as a connection member to extend the effective locking distance of a lock and particularly to a wire lock capable of adjusting the length of the connection member.

### BACKGROUND OF THE INVENTION

Notebook computers are very popular these days. Their portability provides a great benefit and convenience to users. While the notebook computer is easy to carry, it also is easy to be stolen. This happens frequently when it is undergoing charge processing or data transmission unattended. Hence a theft-deterrent device is needed to reduce the risk of pilferage.

One of the examples is U.S. Pat. No. 6,199,413, which provides a security lock for portable articles. It may be inserted into a preset locking port of a notebook computer and fastened to an anchor object (such as a post, desk leg, or the like) through a cable of a fixed length to guard against theft.

However, when the notebook computer is in use, the distance between the notebook computer and the anchor object could vary, such as to show a displayed information file on the screen to other people, or to display the notebook computer in the shop for consumer operation and inspection. The fixed length cable makes moving and use difficult.

Moreover, the cable requires a lot of caring during storing to prevent tangling or messy bundling that could result in difficulties.

Hence although the technique mentioned above can prevent pilferage, the design of the fixed length cable limits its usability and convenience.

Another instance is U.S. Pat. No. 4,896,517, which discloses a wire lock having a self-retractable wire. It includes a combination lock, a wire rope and a reel. The wire rope may be wound in the reel or pulled out from the reel. The wire rope is fastened to the combination lock to form a latch range to couple on an object for locking. The reel can alter the length of the wire rope, being pulled out to change the latch range according to different objects.

### SUMMARY OF THE INVENTION

In view of the aforesaid problems and disadvantages, the primary object of the present invention is to provide a wire lock to link a guarded object and an anchor object at a desired distance through a connection member, and retract and wind the connection member on a winding reel when the link is disengaged, and house a guarding member in a wire lock to shrink the total size to facilitate carrying and storing.

In order to achieve the foregoing object, the present invention provides a retractable wire lock that connects a guarded object to an anchor object at a desired distance. It includes a casing, a first guarding member fastened to the guarded object, a winding reel pivotally housed in the casing and a second guarding member fastened to the anchor object. The guarding members are connected to the winding reel through a connection member. When the connection between the guarding members and the anchor object and the guarded object is released, the connection member may be retracted and wound on the winding reel and the guarding members may be housed in the casing.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the invention in a use-condition.

FIG. 2 is an exploded view of the first embodiment of the invention.

FIG. 3 is a perspective view of the first embodiment of the invention.

FIG. 4A is a schematic view of the first guarding member of the invention in a use-condition.

FIG. 4A-1 is a schematic view of the first guarding member of the invention in another use-condition.

FIG. 4A-2 is a schematic view of the first guarding member of the invention in yet another use-condition.

FIG. 4B is a schematic view of a second guarding member of the invention in a use-condition.

FIG. 4B-1 is a schematic view of a second guarding member of the invention in another use-condition.

FIG. 4B-2 is a schematic view of a second guarding member of the invention in yet another use-condition.

FIG. 5A is a plane view of the structure of the first embodiment of the invention.

FIG. 5B is another plane view of the structure of the first embodiment of the invention.

FIG. 6A is a schematic view of the winding reel and control key of the invention in an operating condition.

FIG. 6B is a schematic view of the winding reel and control key of the invention in another operating condition.

FIG. 7A is a plane view of the structure of the first embodiment of the invention.

FIG. 7B is another plane view of the structure of the first embodiment of the invention.

FIG. 8A is a side view of the structure of a second embodiment of the invention.

FIG. 8B is a plane view of the structure of the second embodiment of the invention.

FIG. 9A is a side view of the structure of the third embodiment of the invention.

FIG. 9B is a plane view of the structure of the third embodiment of the invention.

FIG. 10 is a schematic view of the winding reel of the invention in a use-condition.

### DESCRIPTION OF THE PREFERRED EMBODIMENTS

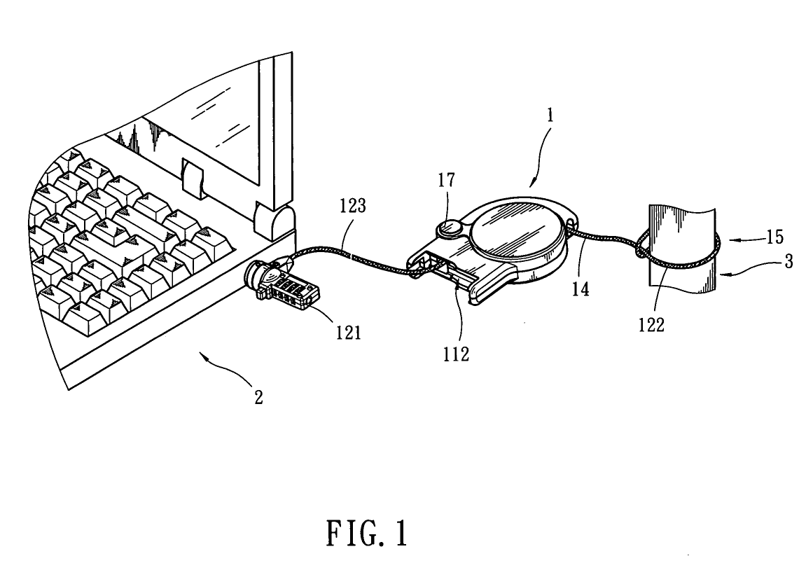

The present invention aims to provide a wire lock 1 to fasten a guarded object 2, such as a notebook computer, to an anchor object 3, such as a desk leg, at a desired distance as shown in FIG. 1.

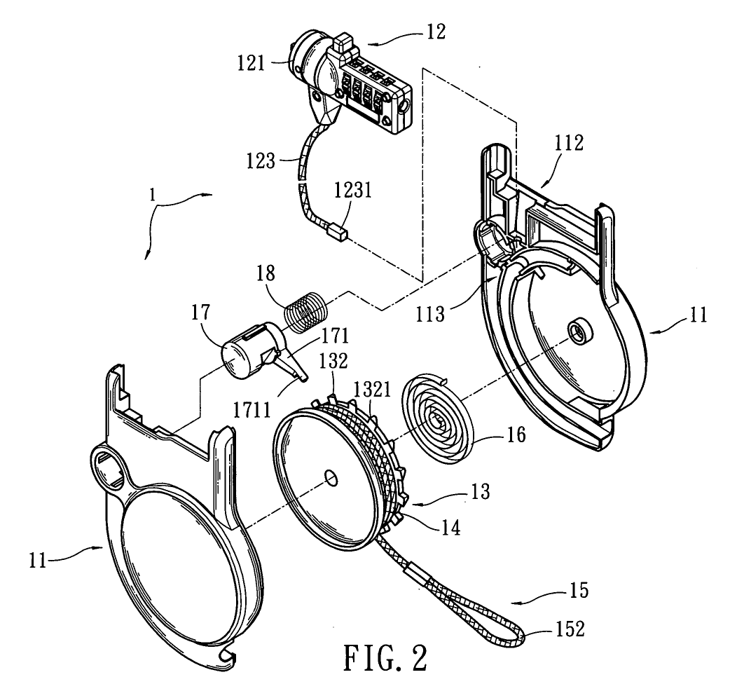

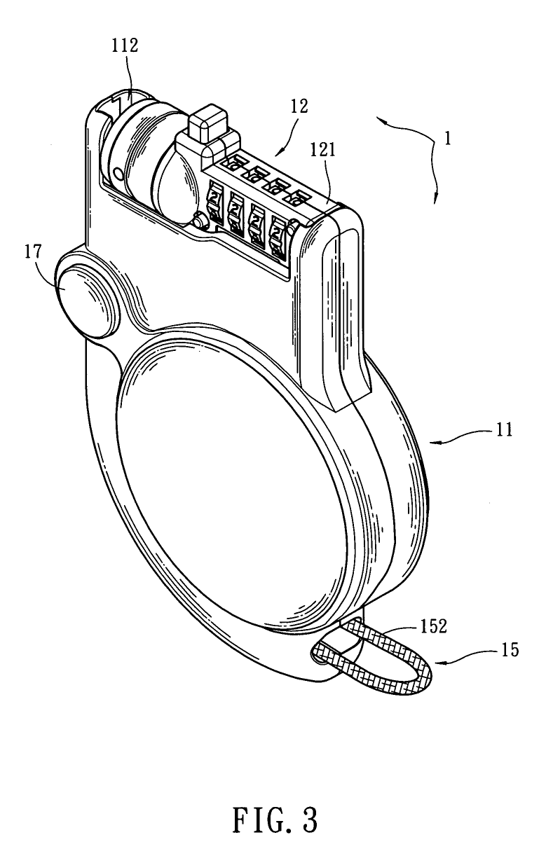

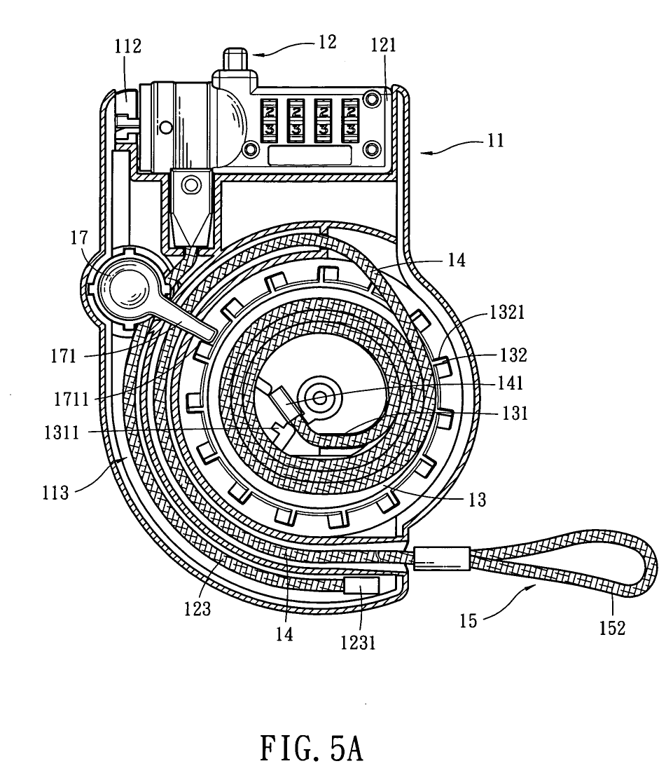

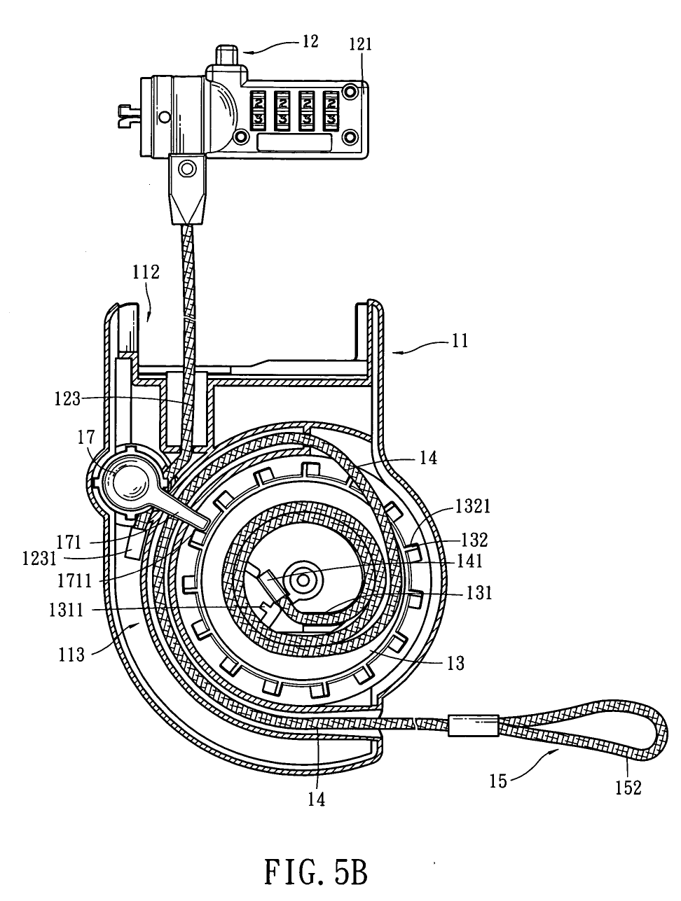

Referring to FIGS. 2 and 3, the invention includes a casing 11, a first guarding member 12, a winding reel 13, a connection member 14 and a second guarding member 15. The first guarding member 12 is fastened to the casing 11 and movable relative to the casing 11 to a use-position, and can be fastened to the guarded object 2. The winding reel 13 is pivotally coupled in the casing 11 and turnable about the pivot center. The winding reel 13 has a port 131 to allow the connection member 14 to pass through. The port 131 has a plurality of latch walls 1311. The connection member 14 has one end passing through the port 131 to couple with a latch sleeve 141 which may be anchored on the latch walls 1311 to enable the connection member 14 to be wound on the winding reel 13 (referring to FIG. 5A). The connection member 14 has the other end fastened to the second guarding member 15, which is fastened to the anchor object 3.

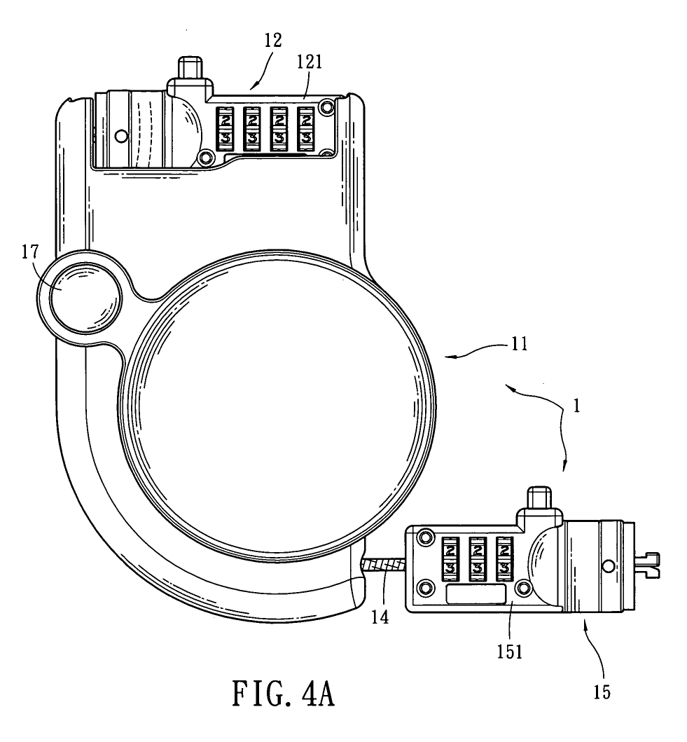

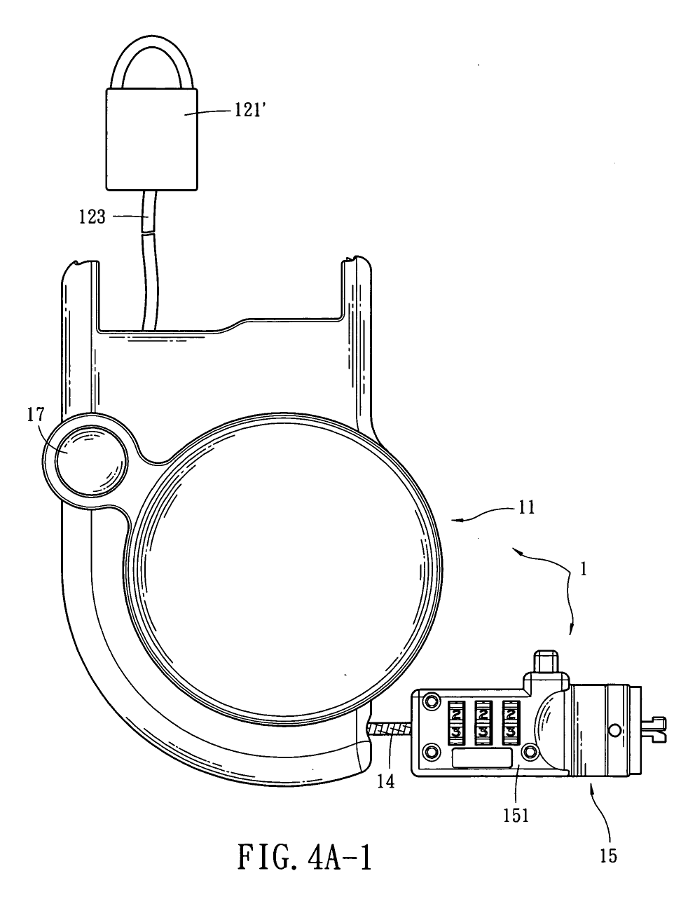

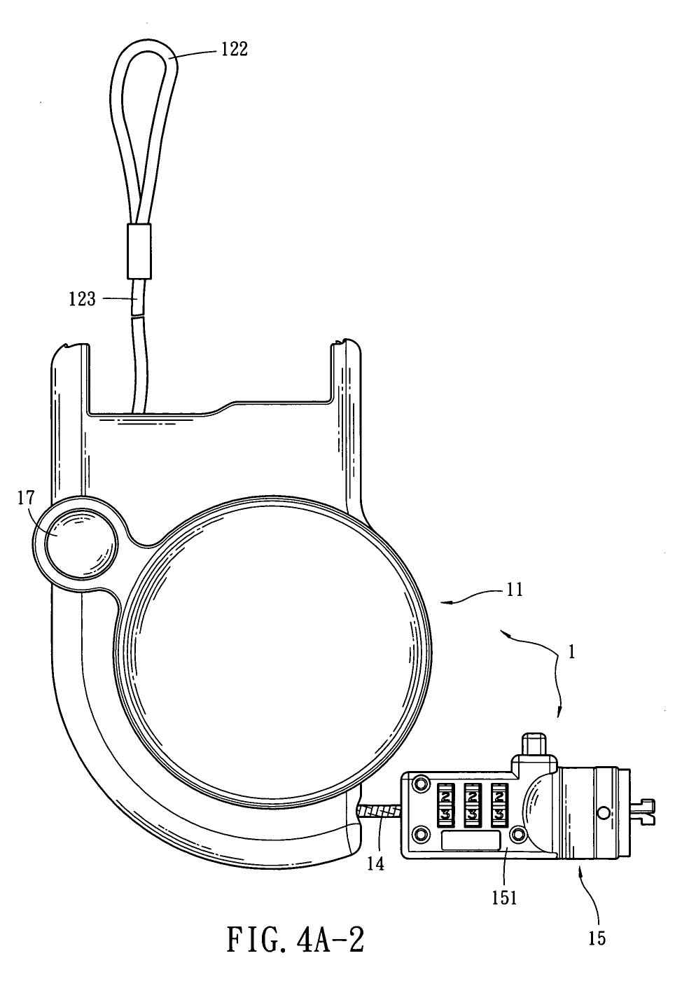

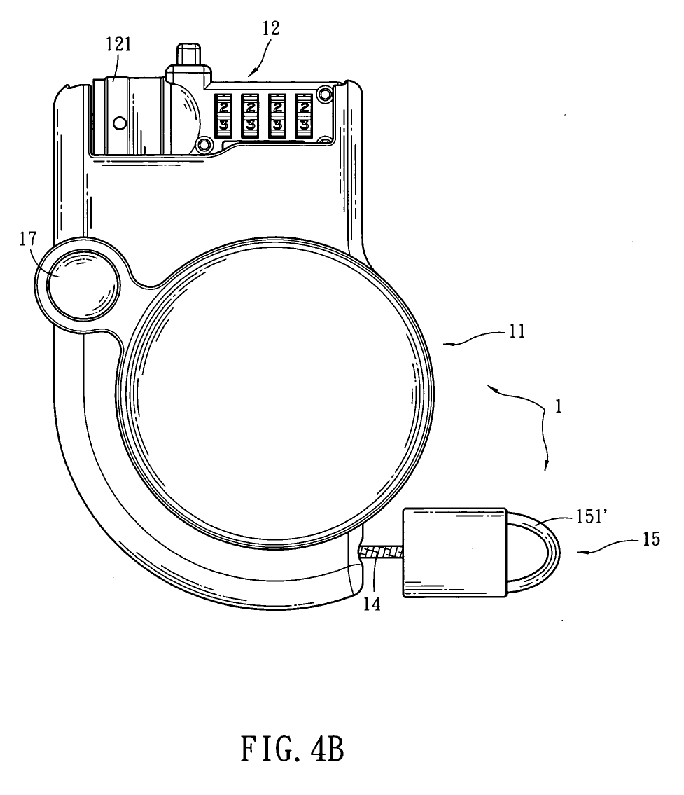

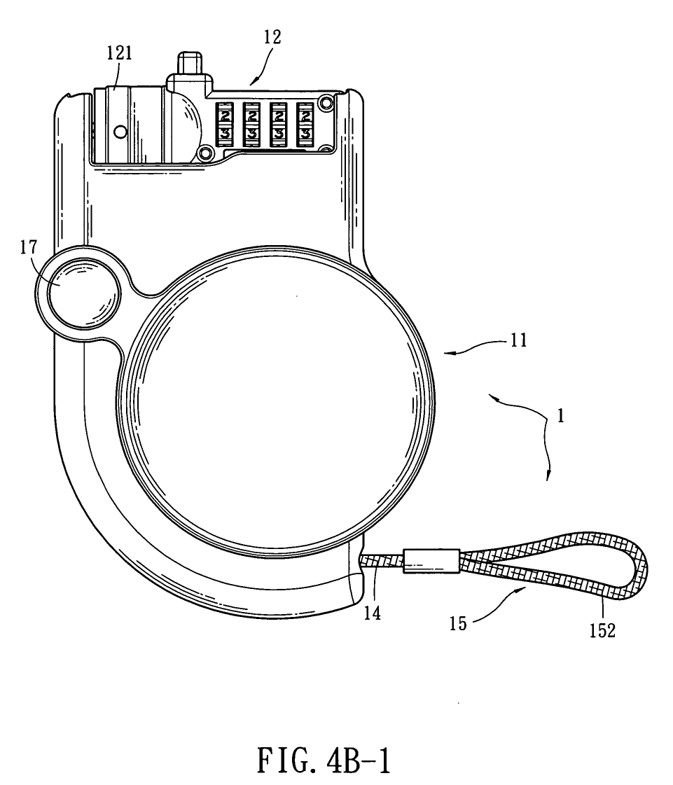

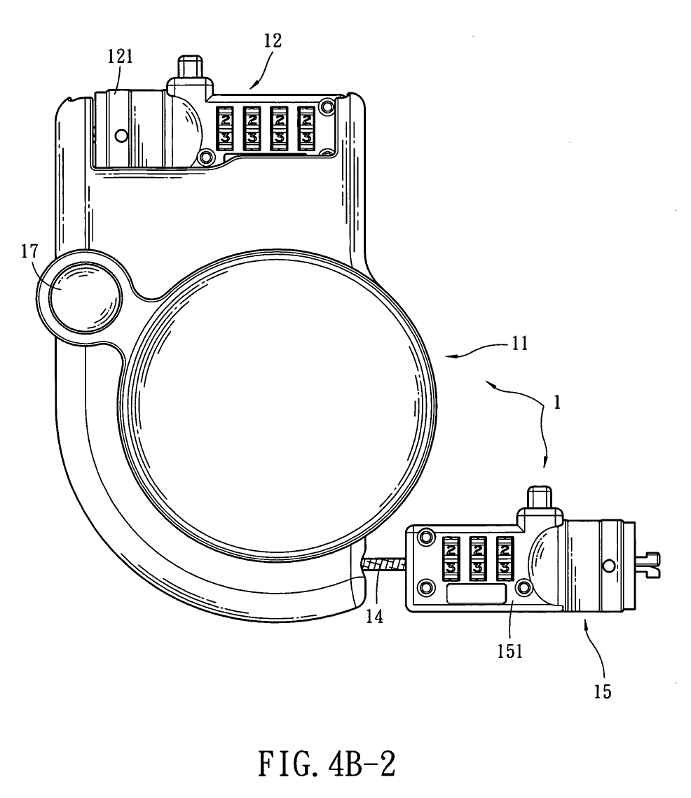

Referring to FIGS. 4A through 4B-2, the first guarding member 12 and the second guarding member 15 may be locks 121 and 151, such as tubular locks, padlocks or the like to provide a locking function, or wire loops 122 and 152. However, in practice, the first guarding member 12 and the second guarding member 15 include at least one lock 121 or 151. The combination may be a lock 121 or 151 to couple with a wire loop 122 or 152, or a lock 121 or 151 to couple with another lock 121′ or 151′ to suit a wide range of user requirements.

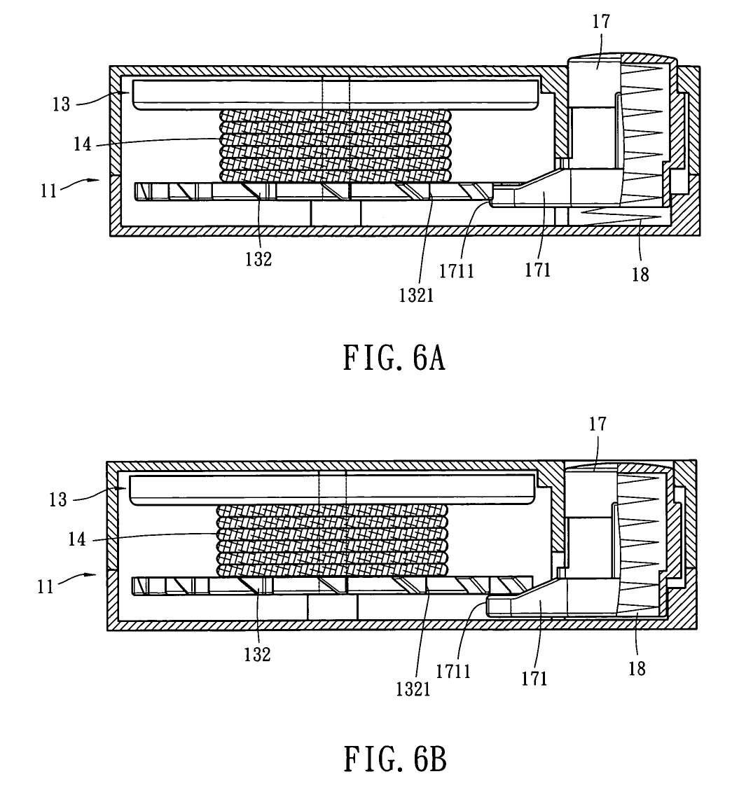

Also referring to FIGS. 5A and 5B, the first guarding member 12 has one side connecting to a connection member 123. The casing 11 has a housing compartment 112 and a passage 113 formed therein. The connection member 123 is housed in the passage 113 and has the other end coupled with a latch sleeve 1231. The housing compartment 112 houses the first guarding member 12 movably at a storing position (as shown in FIG. 5A). There is an elastic element 16 (referring to FIG. 2) located between the winding reel 13 and the casing 11. The elastic element 16 may be a spiral spring which has one end fastened to the casing 11 and the other end fastened to the winding reel 13. The elastic element 16 has an elastic restoring force to automatically drive and wind the connection member 14 fastened to the second guarding member 15 on the winding reel 13 and move the second guarding member 15 close to the casing 11 at a wound position (as shown in FIG. 5A). When in use, pull the first guarding member 12 away from the housing compartment 112, the connection member 123 is confined in the passage 113 because of the latch sleeve 1231 and the first guarding member 12 escapes from the housing compartment 112 to reach a use-position (referring to FIG. 5B). The winding reel 13 has a plurality of latch bosses 132 on the periphery. The casing 11 has a movable control key 17, which has a latch arm 171 extended from one side. Referring to FIGS. 6A and 6B, the latch arm 171 has a first latch side 1711 on a distal end. Each of the latch bosses 132 has a second latch side 1321 corresponding to the first latch side 1711. There is an elastic element 18 located between the control key 17 and the casing 11 to provide an elastic force to keep the latch arm 171 wedged between two neighboring bosses 132 in a normal condition (as shown in FIG. 6A). When the control key 17 is pressed, the latch arm 171 is moved away from the wedged position of the latch bossed 132 (as shown in FIG. 6B). Hence the second guarding member 15 may be pulled out by force. Once the second guarding member 15 is pulled out at a desired distance, the control key 17 may be released to allow the latch arm 171 to be wedged between the latch bosses 132 again to form an anchor condition (referring to FIG. 5B).

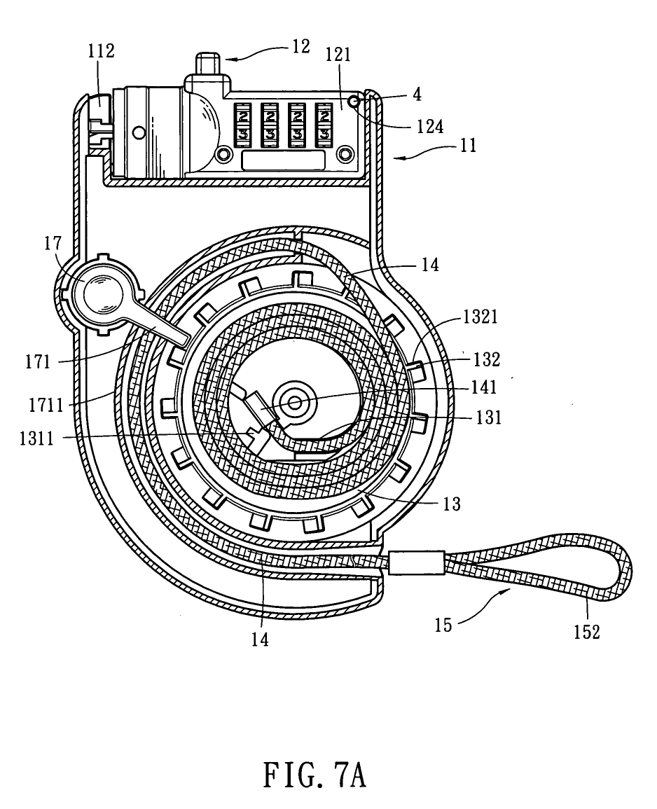

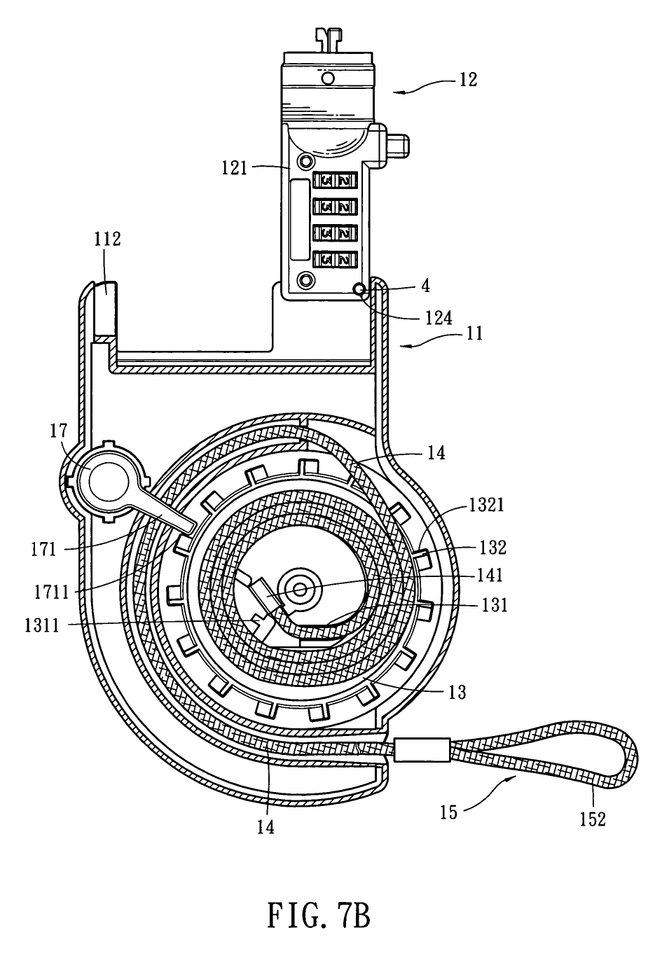

Refer to FIGS. 7A and 7B for a first embodiment of the invention. The casing 11 has a housing compartment 112. The first guarding member 12 has an aperture 124 to couple with a pivot element 4 to enable the first guarding member 12, to be held in the housing compartment 112 at a storing position. When in use, the first guarding member 12 may be moved outwards from the casing 11 to fasten to the guarded object 2, or the first guarding member 12 may be turned about the pivot element 4 to be moved outside the housing compartment 112 to fasten to the guarded object 2. The second guarding member 15 may be pulled out by unwinding the second connection member 14 from the winding reel 13 to fasten to the anchor object 3 at a desired distance to provide a guarding effect.

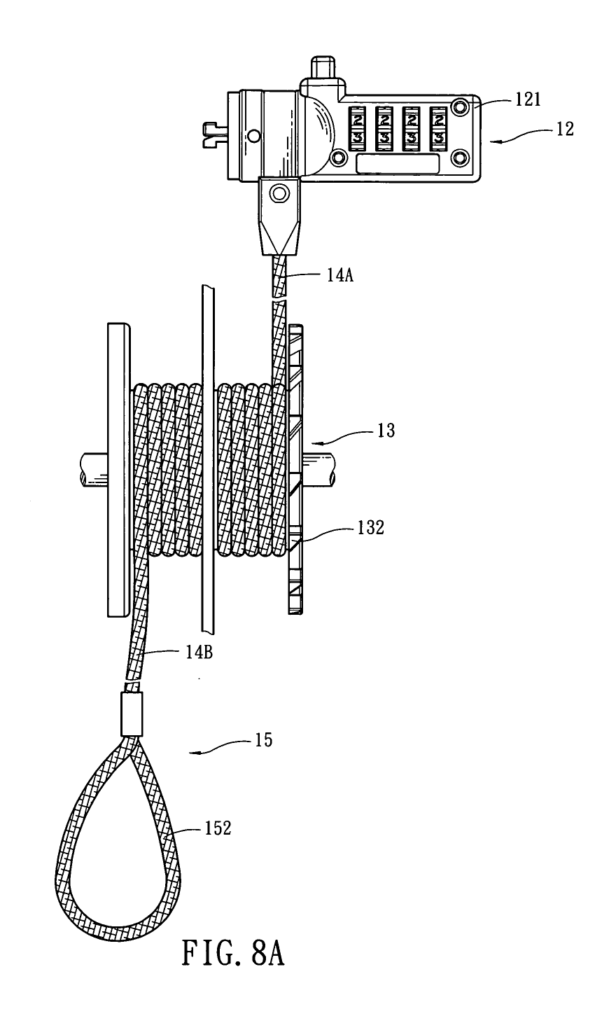

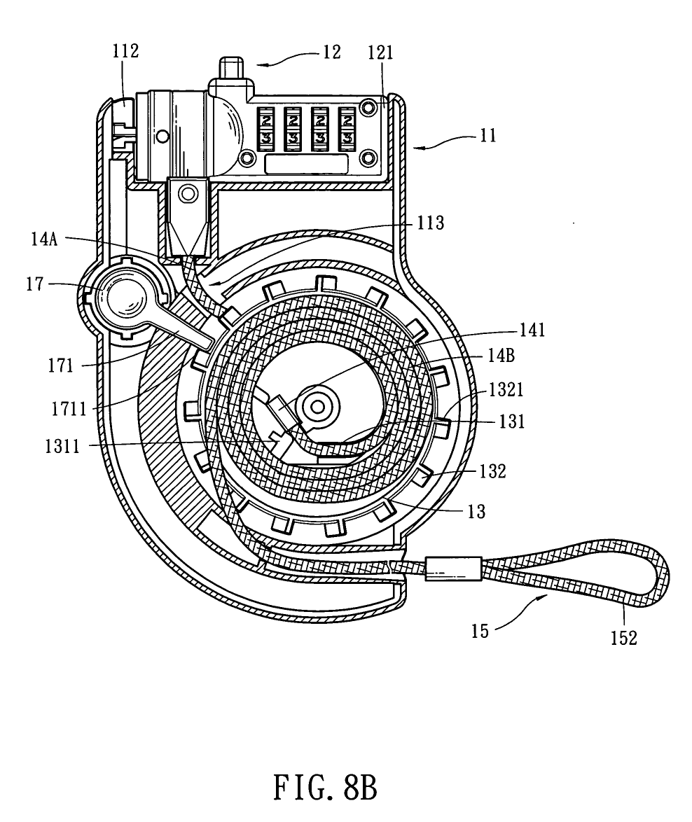

Refer to FIGS. 8A and 8B for a second embodiment of the invention. It has a shared winding reel 13. This embodiment includes a casing 11, a first guarding member 12, a first connection member 14A, a winding reel 13, a second connection member 14B and a second guarding member 15. The winding reel 13 is pivotally coupled in the casing 11 and may be rotated therein.

The first guarding member 12 is fastened to the guarded object 2 and is coupled with the first connection member 14A which has the other end fastened to and wound on the winding reel 13.

The second guarding object 15 is fastened to the anchor object 3 and also is coupled to the second connection member 14B which has the other end fastened to and wound on the winding reel 13.

There is an elastic element 16 (referring to FIG. 2) located between the winding reel 13 and the casing 11. The elastic element 16 may be a spiral spring which has one end fastened to the casing 11 and the other end fastened to the winding reel 13. The elastic element 16 has an elastic restoring force to automatically drive and wind the first connection member 14A and the second connection member 14B on the winding reel 13. The winding reel 13 has a plurality of latch bosses 132 on the periphery. The casing 11 has a movable control key 17, which has a latch arm 171 extended from one side. The latch arm 171 may be movably wedged between two neighboring bosses 132 of the winding reel 13 to enable the first guarding member 12 and the second guarding member 15 to be pulled out or retracted to form an anchor condition.

The casing 11 also has a housing compartment 112 and a passage 113. The first connection member 14A runs through the passage 113 to be wound on the winding reel 13. The first guarding member 12 may be held in the housing compartment 112 at a storing position. The second guarding member 15 may be moved close to the casing 11 at a wound position (as shown in FIG. 8B). When in use, selectively pull the first guarding member 12 or the second guarding member 15 outside the casing 11, the first guarding member 12 or the second guarding member 15 will be moved outside the casing 11 simultaneously. The first guarding member 12 may be extended to fasten to the guarded object 2, while the second guarding member 15 may be fastened to the anchor object 3 to enable the guarded object 2 to be linked to the anchor object 3 at a desired distance to achieve a guarding effect.

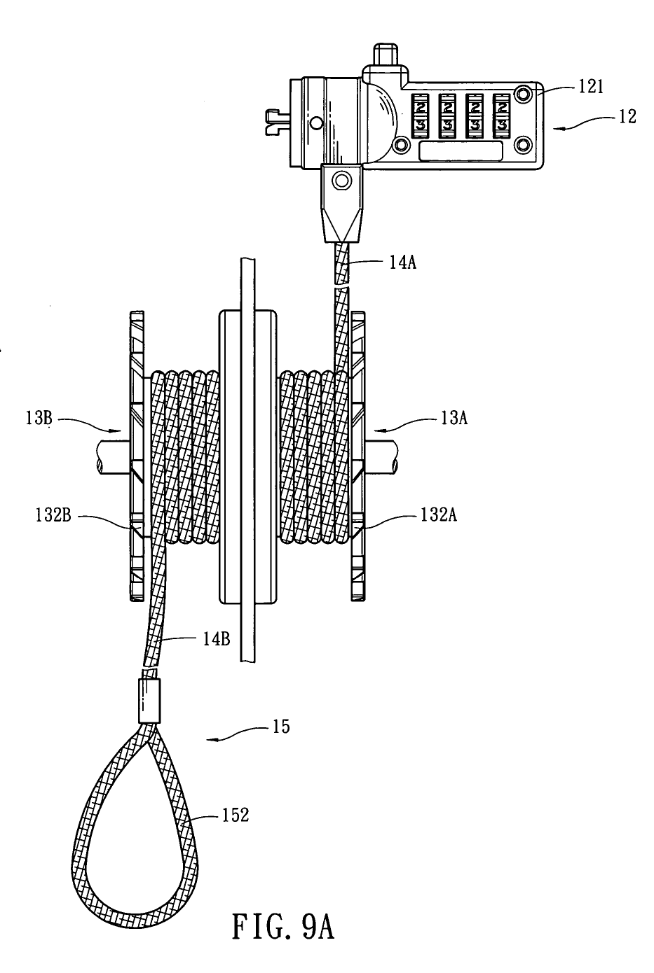

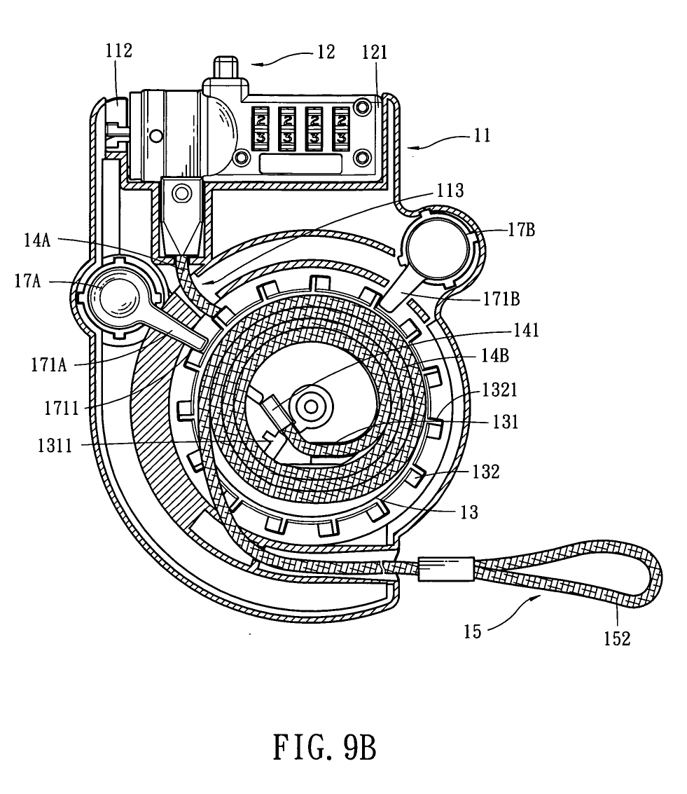

Refer to FIGS. 9A and 9B for the third embodiment of the invention. It adopts separated winding reels. This embodiment includes a casing 11, a first guarding member 12, a winding reel 13A, a first connection member 14A, a second guarding member 15, a second winding reel 13B, and a second connection member 14B. The first winding reel 13A and the second winding reel 13B are pivotally mounted on the casing 11, and are stacked in a coaxial manner or located on different axles, and are turnable therein.

The first guarding member 12 is fastened to one end of the first connection member 14A, which has the other end fastened to and wound on the first winding reel 13A.

The second guarding object 15 is fastened to one end of the second connection member 14B which has the other end fastened to and wound on the second winding reel 13B.

There is an elastic element 16 located respectively between the first winding reel 13A and the casing 11, and between the second winding reel 13B and the casing 11. The elastic element 16 has an elastic restoring force to drive the first winding reel 13A and the second winding reel 13B to wind respectively the first connection member 14A and the second connection member 14B on the first winding reel 13A and the second winding reel 13B. The first winding reel 13A and the second winding reel 13B have respectively a plurality of latch bosses 132A and 132B on the periphery. The casing 11 has two movable control keys 17A and 17B which have respectively a latch arm 171A and 171B extended from one side. The latch arms 171A and 171B may be movably wedged between two neighboring bosses 132A and 132B of the first winding reel 13A and the second winding reel 13B to enable the first guarding member 12 and the second guarding member 15 to be pulled out or retracted to form an anchor condition. The casing 11 also has a housing compartment 112 and a passage 113. The first connection member 14A is held in the passage 113. The first guarding member 12 is movably held in the housing compartment 112 at a storing position. The second guarding member 15 may be retracted close to the casing 11 at a wound position (referring to FIG. 9B). When in use, selectively pull the first guarding member 12 or the second guarding member 15 outside the casing 11. The first guarding member 12 may be extended to fasten to the guarded object 2, while the second guarding member 15 may be fastened to the anchor object 3 to enable the guarded object 2 to be linked to the anchor object 3 at a desired distance to achieve a guarding effect.

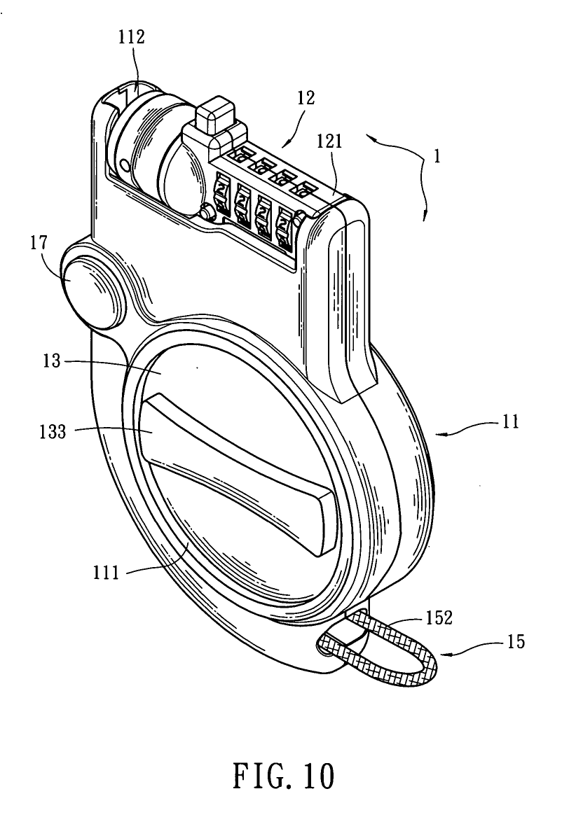

Referring to FIG. 10, in practice, the winding reel 13 may have a grip section 133 on the surface, and the casing 11 has a carved trough 111 on the surface corresponding to the winding reel 13 to expose the grip section 133 to enable users to turn the winding reel 13 manually to wind the connection member.

The embodiments set forth above serve only for illustrative purpose, and are not the limitation of the present invention. The connection members 123 and 14, and the first connection member 14A and the second connection member 14B are flexible wires. Modifications of the disclosed embodiments of the invention as well as other embodiments thereof may occur to those skilled in the art. Accordingly, the appended claims are intended to cover all embodiments, which do not depart from the spirit and scope of the invention.

1. A retractable wire lock for fastening a guarded object to an anchor object at a desired distance, comprising:
a casing;
a first guarding member for fastening to the guarded object and connecting to the casing and being movable relative to the casing to a use-position;
a winding reel pivotally coupled in the casing;
a flexible connection member having one end coupled on the winding reel to be wound thereon for storing; and
a second guarding member for fastening to the anchor object and connecting to the other end of the connection member.

2. The retractable wire lock of claim 1, wherein the winding reel is coupled with an elastic element which provides an elastic restoring force to wind the connection member on the winding reel.

3. The retractable wire lock of claim 2, wherein the winding reel has a plurality of bosses, the casing having a control key which has a latch arm extended from one side thereof to wedge between two neighboring bosses to allow the second connection member to form an anchor position after having been pulled out or wound.

4. The retractable wire lock of claim 1, wherein the winding reel has a grip section located on an outer side of the casing for controlling rotation of the winding reel.

5. The retractable wire lock of claim 1, wherein the casing has a housing compartment to hold the first guarding member at a storing position.

6. The retractable wire lock of claim 5, wherein the first guarding member is coupled to a connection member which has the other end connected to the case, and the first guarding member being movable away from the housing compartment when subject to a force.

7. The retractable wire lock of claim 5, wherein the first guarding member is pivotally coupled in the casing and turnable about a pivot center to the use position.

8. The retractable wire lock of claim 1, wherein at least one of the first guarding member and the second guarding member is a lock.

9. The retractable wire lock of claim 1, wherein one of the first guarding member and the second guarding member is a wire loop.

10. A retractable wire lock for fastening a guarded object to an anchor object at a desired distance, comprising:
a casing;
a winding reel pivotally coupled in the casing;
a flexible first connection member having one end coupled on the winding reel to be wound thereon for storing;
a first guarding member for fastening to the guarded object and connecting to the other end of the first connection member;
a flexible second connection member having one end coupled on the winding reel to be wound thereon for storing; and
a second guarding member for fastening to the anchor object and connecting to the other end of the second connection member.

11. The retractable wire lock of claim 10, wherein the winding reel is coupled with an elastic element which provides an elastic restoring force to simultaneously wind the first connection member and the second connection member on the winding reel.

12. The retractable wire lock of claim 11, wherein the winding reel has a plurality of bosses, the casing having a control key which has a latch arm extended from one side thereof to wedge between two neighboring bosses to allow the first connection member and the second connection member to form an anchor position after having been pulled out or wound.

13. The retractable wire lock of claim 10, wherein the winding reel has a grip section located on an outer side of the casing for controlling rotation of the winding reel.

14. The retractable wire lock of claim 10, wherein the casing has a housing compartment to hold the first guarding member at a storing position.

15. The retractable wire lock of claim 10, wherein at least one of the first guarding member and the second guarding member is a lock.

16. The retractable wire lock of claim 10, wherein one of the first guarding member and the second guarding member is a wire loop.

17. A retractable wire lock for fastening a guarded object to an anchor object at a desired distance, comprising:
a casing;
a first winding reel pivotally coupled in the casing;
a flexible first connection member having one end coupled on the first winding reel to be wound thereon for storing;
a first guarding member for fastening to the guarded object and connecting to the other end of the first connection member;
a second winding reel pivotally coupled in the casing;
a flexible second connection member having one end coupled on the second winding reel to be wound thereon for storing; and
a second guarding member for fastening to the anchor object and connecting to the other end of the second connection member.

18. The retractable wire lock of claim 17, wherein the first winding reel and the second winding reel are pivotally coupled in the casing separately and turnable respectively about a pivot center thereof.

19. The retractable wire lock of claim 17, wherein the first winding reel and the second winding reel are pivotally coupled in the casing in a coaxial manner.

20. The retractable wire lock of claim 17, wherein the first winding reel and the second winding reel are coupled respectively with an elastic element which provides an elastic restoring force to wind respectively the first connection member on the first winding reel and the second connection member on the second winding reel.

21. The retractable wire lock of claim 17, wherein the first winding reel and the second winding reel have respectively a plurality of bosses, the casing having a control key corresponding respectively to the first winding reel and the second winding reel, the control key having a latch arm extended from one side thereof to wedge between two neighboring bosses of the first winding reel and the second winding reel to allow the first connection member and the second connection member to form an anchor position after having been pulled out or wound.

22. The retractable wire lock of claim 17, wherein the first winding reel and the second winding reel have a grip section located on an outer side of the casing for controlling rotation of the first winding reel and the second winding reel.

23. The retractable wire lock of claim 17, wherein the casing has a housing compartment to hold the first guarding member at a storing position, the first guarding member being movable outside the housing compartment to a use-position when subject to a force.

24. The retractable wire lock of claim 17, wherein at least one of the first guarding member and the second guarding member is a lock.

25. The retractable wire lock of claim 17, wherein one of the first guarding member and the second guarding member is a wire loop.
